(19) United States
(12) Patent Application Publication
(10) Pub. No.: US 2025/0077870 A1
(43) Pub. Date: Mar. 6, 2025

(54) System and Method for Generating a Trained Neural Network from a Pretrained Machine Learning Model

(71) Applicant: Microsoft Technology Licensing, LLC, Redmond, WA (US)

(72) Inventors: Andreas Christian Mueller, Los Gatos, CA (US); Carlo Aldo Curino, Woodinville, WA (US); Raghunath Ramakrishnan, Bellevue, WA (US)

(21) Appl. No.: 18/458,257

(22) Filed: Aug. 30, 2023

(51) Int. Cl. G06N 3/084; G06N 3/045

(52) U.S. Cl. CPC G06N 3/084; G06N 3/045

(57) ABSTRACT

A method, computer program product, and computing system for processing training data and prediction data as a plurality of tokens using a classification-based machine learning model. A plurality of weighting features associated with the training data and the prediction data are defined by processing the output of the machine learning model with an attention layer. The plurality of weighting features are reshaped to generate weights for a trained neural network by processing the plurality of weighting features with an attention layer.

### BACKGROUND

The field of generative artificial intelligence (AI) has been experiencing a tremendous surge in the text and vision domains, bringing about a significant transformation across various technological fields. However, these advances have been more limited when applied to tabular data. For example, while generic large language models can be adapted to work on tabular data, the restriction on the number of input tokens severely limits the amount of data that can be ingested. Token limits for many large language models are defined as the combination of the input, output, and instructions. However, even with increasing token limits, conventional generative machine learning models are trained to generate predictions based on input prompts and require significant resources to operate.

### BRIEF DESCRIPTION OF THE DRAWINGS

FIG. 1 is a flow chart of one implementation of a trained neural network generation process;

FIG. 2 is a diagrammatic view of the trained neural network generation process of FIG. 1 during inference;

FIG. 3 is a diagrammatic view of the trained neural network generation process of FIG. 1 during training;

FIG. 4 is a diagrammatic view of a trained neural network classifying tabular data; and

FIG. 5 is a diagrammatic view of computer system and a trained neural network generation process coupled to a distributed computing network.

Like reference symbols in the various drawings indicate like elements.

### DETAILED DESCRIPTION

Implementations of the present disclosure provide a foundation machine learning model that processes an input training data set of tabular data and an input prediction dataset of tabular data to generate a fully trained neural network. For example, as opposed to producing hyper-parameters or candidate machine learning model architectures, the foundation machine learning model directly generates a trained neural network. As will be discussed in greater detail below, implementations of the present disclosure train a universal machine learning model on millions of tabular classification tasks to generate a trained neural network with its corresponding weights specific to one “target” classification task (provided as a prompt). Moving from direct inference to weight-generation significantly improves on inference cost and scalability, embracing the generality and ease of use of foundation machine learning models while retaining the efficiency of smaller custom models.

For example, implementations of the present disclosure process training data and prediction data as a plurality of tokens using a classification-based machine learning model. In one example, the classification-based machine learning model is a foundation machine learning model trained on tabular data. Specifically, the classification-based machine learning model is trained using a plurality of synthetic tabular datasets and back-propagation. The classification-based machine learning model defines a plurality of weighting features associated with the training data and the prediction data. The plurality of weighting features are reshaped to generate weights for a trained neural network by processing the output of the machine learning model with an attention layer. The weights are used to directly generate a fully trained neural network. In this manner, the classification-based machine learning model is able to generate a trained neural network in a single forward pass without subsequent fine-tuning.

The details of one or more implementations are set forth in the accompanying drawings and the description below. Other features and advantages will become apparent from the description, the drawings, and the claims. The Trained Neural Network Generation Process:

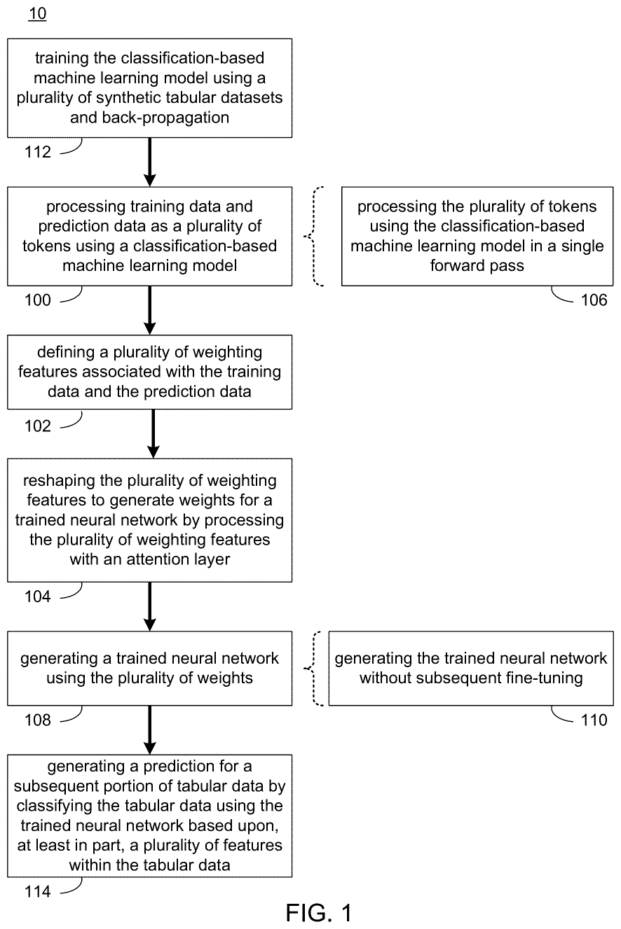

Referring to FIGS. 1-4, trained neural network generation process 10 processes 100 training data and prediction data as a plurality of tokens using a classification-based machine learning model. A plurality of weighting features associated with the training data and the prediction data are defined 102 by processing the output of the machine learning model with an attention layer. The plurality of weighting features are reshaped 104 to generate weights for a trained neural network by processing the plurality of weighting features with an attention layer.

In some implementations, trained neural network generation process 10 processes 100 training data and prediction data as a plurality of tokens using a classification-based machine learning model. Classification is a supervised machine learning method where the machine learning model tries to predict the correct label of a given input data. In classification, the machine learning model is fully trained using the training data, and then it is evaluated on test or prediction data before being used to perform prediction on new unseen data. A classification-based machine learning model (e.g., classification-based machine learning model 200) processes input data in the form of tokens. In one example, the classification-based machine learning model is trained for binary classification (i.e., to classify input data (e.g., input tabular data 202, 204, 206)) into a single category or not. In another example, the classification-based machine learning model is trained for multi-class classification (i.e., to classify input data into one of multiple potential classes). In some implementations, trained neural network generation process 10 converts or transforms training data and prediction data from input tabular data 202, 204, 206 into a plurality of tokens (e.g., training data tokens 208, 210, 212 and prediction data 214, 216, 218, respectively) for processing by the classification-based machine learning model. For example, trained neural network generation process 10 performs tokenization on the training data and the prediction data to divide the training data and the prediction data into portions.

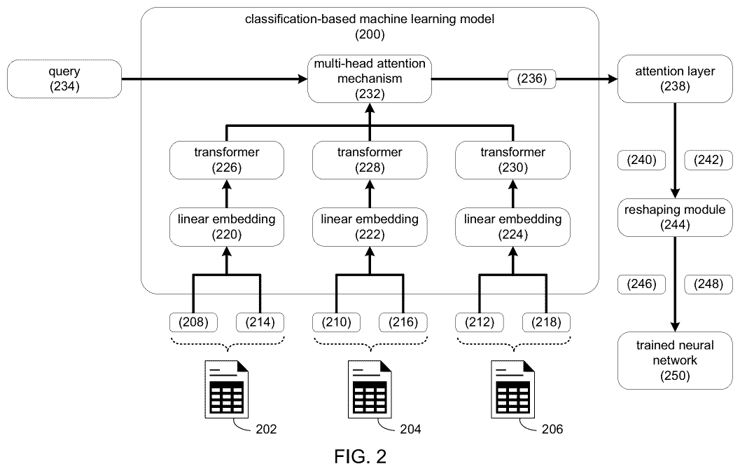

In some implementations, the training data and the prediction data are tabular data. For example, tabular data includes the data in tables, spreadsheets, and other data structures. Tabular data is generally considered to be the most common data type in machine learning applications. While machine learning models (e.g., generic language models) can be adapted to work on tables and tabular data, these machine learning models typically have significant restrictions on the number of input tokens that can be ingested. For example, in a comparison of the memory usage of a large language model (e.g., LLAMA) with that of a transformer for numeric data (e.g., TabPFN), the large language model has a vocabulary size of 32,000 and an embedding dimension of 4,096 (in the smallest version). Expressing a single feature in the iris dataset, which are decimals with two places, takes four tokens, so approximately 4,096*4=16,384 floating point numbers or a sparse vector of length 32,000*4=128,000. Using a transformer for floating point tables, it takes a single floating point number. Expressing the whole iris dataset (e.g., four features, three classes, and 150 data points) in a way consumable by a large language model yields 5,000 to 15,000 tokens, depending on the tokenizer and JSON representation, which is above the capability of most large language models (e.g., LLAMA supports 2,048, the largest current model, GPT-4, up to 32,000, while TabPFN shows scaling to 100 features and 1,000 data points (up to 5,000 in extrapolation experiments)). Notably, the token limits on the large language model combine input, output, and instructions, while the limitations in the transformer for numeric data are for the training set, with the assumption of a test/prediction set of the same size. Accordingly, trained neural network generation process 10 adapts a classification-based model for tabular data. As shown in FIG. 2, tabular data 202, 204, 206 defines training data 208, 210, 212 and corresponding prediction data 214, 216, 218, respectively.

In some implementations, the classification-based model is a foundation machine learning model trained on tabular data. As discussed above, generic machine learning models are generally unable to efficiently process tabular data due to the limitations in token input size. Accordingly, classification-based machine learning model is a foundation machine learning model that is trained on tabular data. As will be discussed in greater detail below, classification-based machine learning model 200 is a foundation machine learning model that is trained on a broad array or range of tabular data (e.g., tables with various rows and columns of data).

In some implementations, processing 100 the training data and the prediction data includes processing 106 the plurality of tokens using the classification-based machine learning model in a single forward pass. Referring again to FIG. 2, trained neural network generation process 10 may process 100 training data 208, 210, 212 and prediction data 214, 216, 218 in a plurality of linear embeddings (e.g., linear embeddings 220, 222, 224) and a plurality of transformers (e.g., transformers 226, 228, 230). While FIG. 2 shows three sets of training data, prediction data, linear embeddings, and transformers, it will be appreciated that any number of sets of training data, prediction data, linear embeddings, and transformers can be used within the scope of the present disclosure.

In some implementations, training data 208, 210, 212 includes a number of features (e.g., “r” features) and a number of classes (e.g., “c” classes) for classifying the data. In one example, training data 208 includes a row of tabular data with “r” features and “c” classes that correspond to prediction data 214. Similarly, training data 210 includes a row of tabular data with “r” features and “c” classes that correspond to prediction data 216 and training data 212 includes “r” features and “c” classes that correspond to prediction data 218. In some implementations, linear embeddings 220, 222, 224 are layers that map training data 208, 210, 212 and prediction data 214, 216, 218 from a high-dimensional to a lower-dimensional space, allowing classification-based machine learning model 200 to learn more about the relationship between inputs and to process the data more efficiently. Transformers 226, 228, 230 are neural networks that learn context by tracking relationships in sequential data. For example, input training data (e.g., training data 208, 210, 212) is encoded as tokens and each token is converted into a vector via looking up from an embedding table (e.g., linear embeddings 220, 222, 224). At each linear embedding layer, each token is contextualized within the scope of the context window with other (unmasked) tokens via parallel multi-head attention mechanism (e.g., multi-head attention mechanism 232).

### PFN Overview

As shown in FIG. 2, classification-based machine learning model 200 maintains the structure of input encoding and transformer layers of TabPFN. TabPFN is a Prior-Data Fitted Network (PFN) and is trained offline once, to approximate Bayesian inference on a plurality of tabular synthetic datasets. Regarding PFNs generally, in the Bayesian framework for supervised learning, the prior defines a space of hypotheses P on the relationship of a set of inputs x to the output labels y. Each hypothesis p E can be seen as a mechanism that generates a data distribution from which samples are drawn forming a dataset. For example, given a prior based on structural causal models, (is the space of structural causal models, a hypothesis p is one specific structural causal model (SCM), and a dataset comprises samples generated through this SCM. In practice, a dataset comprises training data with observed labels and test data where labels are missing or held out to assess predictive performance. The posterior predictive distribution (PPD) for a test sample xₜₑₛₜ specifies the distribution of its label p(xₜₑₛₜ, Dₜᵣₐᵢₙ), which is conditioned on the set of training samples Dₜᵣₐᵢₙ:={(x₁, y₁), . . . , (xₙ, yₙ)}. The PPD can be obtained by integration over the space of hypotheses Φ, where the weight of a hypothesis ϕ∈Φ is determined by its prior probability p(ϕ) and the likelihood p(D|ϕ) of the data D given ϕ as shown in Equation 1 below:

$$p ( y \vert x , D ) ∝ {\int }_{Φ} p ( y \vert x , ϕ ) p ( D \vert ϕ ) p ( ϕ ) d ϕ \qquad ( 1 )$$

In some implementations, prior-fitting is the training of a PFN to approximate the PPD and thus do Bayesian prediction. It is implemented with a prior which is specified by a prior sampling scheme of the form p(D)=E_{ϕ˜p(ϕ)}[p(D|ϕ)], which first samples hypotheses (generating mechanisms) with φ˜-p(ϕ) and then synthetic datasets with D˜p(D|ϕ). Synthetic datasets D:=(xᵢ, yᵢ) i∈{1, . . . , n} are repeatedly sampled and the PFN's parameters θ are optimized to make predictions for Dₜₑₛₜ⊂D, conditioned on the rest of the dataset Dₜᵣₐᵢₙ=D\Dₜₑₛₜ. The loss of the PFN training thus is the cross-entropy on held-out examples of synthetic datasets. For a single test point {(xtest, ytest)}=Dtest, the training loss can be written as shown in Equation 2:

$${ℒ}_{PFN} = {( \{ ( {x}_{t e s t} . {y}_{t e s t} ) \} ⋃ {D}_{train} ) ∼ p ( D )}^{} [ - log {q}_{θ} ( {y}_{t e s t} \vert {x}_{t est} , {D}_{train} ) ] \qquad ( 2 )$$

In some implementations, minimizing this loss approximates the true Bayesian posterior predictive distribution. The synthetic prior-fitting phase is performed only once for a given prior p(D) as part of algorithm development. During inference, the trained model is applied to unseen real-world datasets. For a novel dataset with training samples Dₜᵣₐᵢₙ and test features xₜₑₛₜ, feeding (Dₜᵣₐᵢₙ, xₜₑₛₜ) as an input to the model trained above yields the PPD q_{θ}(y|xₜₑₛₜ, Dₜᵣₐᵢₙ) in a single forward-pass. The PPD class probabilities are then used as predictions for our real-world task. Thus, PFNs perform training and prediction in one step (similar to prediction with Gaussian Processes) and do not use gradient-based learning on data seen at inference time.

Regarding architecture, PFNs rely on a transformer that encodes each feature vector and label as a token, allowing token representations to attend to each other. They accept a variable length training set Dₜᵣₐᵢₙ of feature and label vectors (treated as a set-valued input to exploit permutation invariance) as well as a variable length query set of feature vectors xₜₑₛₜ={x_{(test, 1)}, . . . x_{(test, n)}} and return estimates of the PPD for each query.

### Tabular Data Prior

Regarding the prior, tabular datasets comprise a range of peculiarities, e.g. feature types can be numerical, ordinal, or categorical and feature values can be missing, leading to sparse features. These issues are typically addressed by pre-processing, feature correlation, generating irregular functions, and using categorical features. For example, during prior-fitting, input data is normalized to zero mean and unit variance, and the same step is applied when evaluating on real data. Since tabular data frequently contains exponentially scaled data, which might not be present during prior-fitting, power scaling is applied during inference. Thus, during inference on real tabular datasets, the features more closely match those seen during prior-fitting. In one example, training samples are used only for calculating z-statistics, power transforms and all other preprocessing.

Feature correlation in tabular data varies between datasets and ranges from independent to highly correlated. This poses problems to classical deep learning methods. When considering a large space of SCMs, correlated features of varying degrees naturally arise in the priors. Furthermore, in real-world tabular data, the ordering of features is often unstructured, however adjacent features are often more highly correlated than others. In one example, “Blockwise feature sampling” is used to reflect the correlation structure between ordered features. The generation method of SCMs naturally provides a way to do this. For example, the first step in generating our SCMs is generating a unidirectional layered network structure in which nodes in one layer can only receive inputs from the preceding layer. Thus, features in the same layer tend to be more highly correlated. This is used by sampling adjacent nodes in the layered network structure in blocks and using these ordered blocks in our set of features.

In some implementations with real-world data, some features are consistently more important than others. While a random network weight initialization leads to slightly different feature importances, the average effect of input features regresses to the mean when the hidden dimensionality increases. These differences are amplified by sampling a weight parameter for each input feature and multiplying all outgoing weights by this factor. In the prior, connections of the graph are randomly sparsified. Thus hidden variables and the output node are influenced by fewer parameters, yielding more irregular patterns, as a larger number of parameters regresses to the mean. Sparsification is also extended to blocks of variables, leading to some groups of variables interacting more strongly. The way noise variables are sampled is also sparsified. Instead of sampling Gaussian noise at each node from the same distribution, separate noise means and standard deviations are first sampled for each node and then sampled from this distribution. Also, non-uniformly distributed input data x are generated, as observed in real-world data. The input variables x (which are propagated through our network) are sampled from a mix of distributions, namely the Gaussian, Zipfian and Multivariate Distribution.

In some implementations, tabular data includes not only numeric features but also discrete categorical ones. While categorical features should technically not be ordered, in practice, they sometimes are (i.e., the categories represent binned degrees of some underlying variable). Categorical features are defined by picking a random fraction p_{cat} (a hyperparameter) of categorical features per dataset. Analogous to transforming numeric class labels to discrete multiclass labels, dense features are converted to discrete ones. Also analogous to multiclass labels, a shuffling fraction of categorical features p_{scat} are selected where the categories are reshuffled.

The performance of a TabPFN crucially depends on the specification of a suitable prior, as the PFN approximates the PPD for this prior. For example, distributions are used instead of point-estimates for almost all of the prior's hyperparameters. Fitting a model typically requires finding suitable hyperparameters (e.g., the embedding size, number of layers and activation function for NNs). Commonly, resource-intensive searches are employed to find suitable hyperparameters. The result of these searches, though, is only a point estimate of the hyperparameter choice. Ensembling over multiple architectures and hyperparameter settings can yield a rough approximation to a distribution over these hyperparameters. This, however, scales linearly in cost with the number of choices considered. In contrast, PFNs allow us to be fully Bayesian about our prior's hyperparameters. By defining a probability distribution over the space of hyperparameters in the prior, such as BNN architectures, the PPD approximated by the TabPFN jointly integrates over this space and the respective model weights. This approach is extended to a mixture not only over hyperparameters but distinct priors. In one example, a Bayesian Neural Networks (BNN) prior and a Structural Causal Model (SCM) prior are mixed, each of which entails a mixture of architectures and hyperparameters.

Causal knowledge can facilitate various ML tasks, including semi-supervised learning, transfer learning and out-of-distribution generalization. Tabular data often exhibits causal relationships between columns, and causal mechanisms have been shown to be a strong prior in human reasoning. Thus, the TabPFN prior is based on SCMs that model causal relationships. An SCM consists of a collection Z:=({z₁, . . . , zₖ}) of structural assignments (called mechanisms): zᵢ=fᵢ(z_{PA}_{_{G}}₍ᵢ₎,εᵢ), PA_{G(i)} is the set of parents of the node i (its direct causes) in an underlying DAG G (the causal graph), fᵢ is a (potentially non-linear) deterministic function and zᵢ is a noise variable. Causal relationships in G are represented by directed edges pointing from causes to effects and each mechanism zᵢ is assigned to a node in G.

Previous works have applied causal reasoning to predict observations on unseen data by using causal inference, a method which seeks to identify causal relations between the components of a system by the use of interventions and observational data The predicted causal representations are then used to make observational predictions on novel samples or to provide explanations. Most existing work focuses on determining a single causal graph to use for downstream prediction, which can be problematic since most kinds of SCMs are non-identifiable without interventional data, and the number of compatible DAGs explodes due to the combinatorial nature of the space of DAGs. More recent approaches use transformers to approximate the causal graphs from observational and interventional data. In some implementations, explicit graph representation is skipped entirely in the inference step and the PPD is approximated directly. In this example, causal inference is not performed but the downstream prediction task is performed directly.

To create a PFN prior based on SCMs, a sampling procedure is defined that creates supervised learning tasks (i.e., datasets). Here, each dataset is based on one randomly-sampled SCM (including the DAG structure and deterministic functions fᵢ). Given an SCM, a set z_{X} of nodes in the causal graph G, one for each feature in the synthetic dataset, as well as one node z_{y} from G. These nodes are observed nodes: values of z_{X} are included in the set of features, while values from z_{y} act as targets. For each such SCM and list of nodes z_{X} and z_{y}, n samples are generated by sampling all noise variables in the SCM n times, propagating these through the graph and retrieving the values at the nodes z_{X} and z_{y} for all n samples. The resulting features and targets are correlated through the generating DAG structure. This leads to features conditionally dependent through forward and backward causation, i.e., targets might be a cause or an effect of features.

As discussed above and in some implementations, a BNN prior is mixed with the SCM prior described above by randomly sampling datasets during PFN training from either one or the other prior with equal probability. To sample a dataset from the BNN prior, an NN architecture and its weights are sampled. For each data point in the to-be-generated dataset, an input x is sampled, fed through the BNN with sampled noise variables and use the output y as a target.

The above-described priors return scalar labels. In order to generate synthetic classification labels for imbalanced multi-class datasets, scalar labels y are transformed to discrete class labels y. In one example, the values of \hat{f} are split into intervals that map to class labels. For example, the number of classes N_{c}˜p(N_{c}) are sampled, where p(N_{c}) is a distribution over integers. N_{c}−1 class bounds Bᵢ are sampled randomly from the set of continuous targets ŷ. Each scalar label ŷᵢ is mapped to the index of the unique interval that contains it as shown below in Equation 3:

$${y}_{i} ← {\sum }_{j} [ {B}_{j} < {\hat{y}}_{i} ] \qquad ( 3 )$$

where [⋅] is the indicator function.

For example, with N_{c}=3 classes, the bounds B_{c}={−0.1, 0.5} define three intervals: {(−∞, −0.1], (−0.1, 0.5], (0.5, ∞)}. Any ŷᵢ would be mapped to the label 0 if it is smaller than −0.1, to 1 if lies in (−0.1, 0.5], and to 2 otherwise. Finally, the labels of the classes are shuffled (i.e., by removing the ordering of class labels with respect to the ranges).

### TabPFN Overview

TabPFN is a Prior-data Fitted Network that is fitted on data sampled from a novel prior for tabular data. The TabPFN is formed from a modification of the original PFN architecture in two ways: i) with slight modifications made to the attention masks, yielding shorter inference times, and ii) by enabling the model to work on datasets with different numbers of features by zero-padding. For example, the original PFN architecture uses a single multi-head self-attention module to compute attention between all the training examples, as well as, the attention from validation examples to training examples. This multi-head self-attention module is replaced with two modules that share weights, one which computes self-attention among the training examples and the other that only compute cross-attention from validation examples to training examples. Conceptually, this is equivalent to the original architecture, except that a slightly different self-attention mask is used than in the original architecture, which allowed all examples to attend to itself. For validation examples, the attention to themselves is removed. However, information about the state of the current position does still flow through the residual branch.

In some implementations, datasets have unequal numbers of input dimensions (features), while PFNs use an encoder layer that accepts fixed dimension inputs. Datasets with different numbers of dimensions can be modelled with a single PFN by drawing the number of dimensions of a dataset during training uniformly at random up to 100. The encoder changes to accommodate this training and inference with different numbers of features by zero-padding datasets where the number of features k is smaller than the maximum number of features K and scaling these features by K/k such that the magnitude stays the same.

In one example, a final TabPFN model is trained for 18,000 steps with a batch size of 512 datasets. In this example, the modified TabPFN is trained on 9,216,000 synthetically generated datasets. This training takes 20 hours on 8 GPUs (Nvidia® RTX 2080 Ti). Each dataset had a fixed size of 1,024 and is split it into training and validation uniformly at random. Learning curves tended to flatten after around 10 million datasets and were generally very noisy. This is most likely because the prior generates a wide variety of different datasets. Regarding prior hyperparameters, the hyperparameters of the prior were chosen based on simplicity and observations on the validation datasets (such as their class distributions or feature correlation strengths). Also, during algorithm development, models were evaluated on this set of datasets to decide if the developed methods were correct and working. Since the prior hyperparameters specify distributions and not definite values, they can be chosen over a wide range and resemble the intervals chosen for a random hyperparameter search.

As described above, TabPFN trains a machine learning model that generalizes supervised classification on real-world tabular datasets. In some implementations, trained neural network generation process 10 extends classification-based machine learning model 200 beyond TabPFN to generate a dataset-specific trained neural network. In this example, classification-based machine learning model 200, as with TabPFN, generates activations of size “m” for each pair of training data and corresponding prediction data (e.g., training data 208, 210, 212 and prediction data 214, 216, 218, respectively). In some implementations, multi-head attention mechanism 232 includes another attention layer that, based on query 234, reduces all activations to a single dataset embedding (e.g., embedding 236) of size “n”. In some implementations, query 234 is present only in the multi-head attention mechanism at the top of the transformer and not in every layer of the transformer. This allows trained neural network generation process 10 to control the size “n” of embedding 236 independent of the embedding size of the activations in the transformer (e.g., activation size “m”).

In some implementations, trained neural network generation process 10 defines 102 a plurality of weighting features associated with the training data and the prediction data. For example, trained neural network generation process 10 decodes embedding 236 from classification-based machine learning model 200 to generate a plurality of weighting features. For example and as shown in FIG. 2, trained neural network generation process 10 decodes (i.e., converts) embedding 236 using an attention layer (e.g., attention layer 238) into a plurality of weighting features (e.g., weighting features 240, 242). In one example, attention layer 238 is a portion of neural network (e.g., a two-hidden-layer feed forward neural network) that decodes embedding 236 into a vector of weighting features (e.g., weighting features 240, 242).

In some implementations, trained neural network generation process 10 reshapes 104 the plurality of weighting features to generate weights for a trained neural network by processing the plurality of weighting features with an attention layer. For example, weighting features 240, 242 describe the biasing of particular layers of a trained neural network. In one example, suppose that weighting features 240, 242 describe a vector with 66,954 entries. In this example, the number 66,954 corresponds to weights and biases for a neural network with an input embedding dimension size of 512, a hidden layer with a size of 128, and an output layer with a size of 10. Trained neural network generation process 10 reshapes 104 (e.g., using reshaping module 244) weighting features 240, 242 to generate a plurality of weights and biases (e.g., weights 246, 248) for a trained neural network (e.g., trained neural network 250). Reshaping module 244 is a hardware and/or software component that reshapes 104 the plurality of weighting features 240, 242, by modifying the vector of weighting features 240, 242 into a plurality of weight matrices and biases (e.g., weights 246, 248).

In some implementations, trained neural network generation process 10 generates 108 a trained neural network using the plurality of weights. For example, trained neural network generation process 10 generates trained neural network 250 using the plurality of weights and biases (e.g., weights 246, 248). In one example, generating 108 trained neural network 250 includes inserting weight matrices and bias vectors (e.g., weights 246, 248) reshaped from weighting features 240, 242 into layers of trained neural network 250. Accordingly, trained neural network 250 is not trained before weights 246, 248 are applied to the layers of trained neural network 250. As weights 246, 248 are predefined by classification-based machine learning model 200, trained neural network is able to generate 110 predictions for input data without further training. In this manner, trained neural network 250 is trained without any subsequent fine-tuning in a single forward pass of classification-based machine learning model 200.

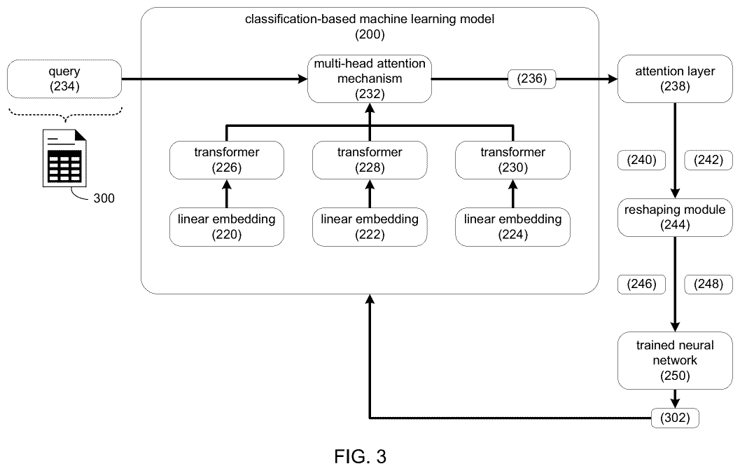

In some implementations, trained neural network generation process 10 trains 112 the classification-based machine learning model using a plurality of synthetic tabular datasets and back-propagation. For example and referring also to FIG. 3, classification-based machine learning model 200 is provided with training data (e.g., plurality of synthetic tabular datasets 300) as input. Trained neural network generation process 10 trains classification-based machine learning model 200 by processing input rows and corresponding results from synthetic tabular datasets 300. In one example, trained neural network generation process 10 trains 112 classification-based machine learning model 200 by using the results from plurality of synthetic tabular datasets and the output of classification-based machine learning model 200 (e.g., output 302) for corresponding input tabular data (e.g., input data 300) to perform back propagation in classification-based machine learning model 200. For example, trained neural network generation process 10 trains 112 classification-based machine learning model 200 using back propagation through the whole architecture of classification-based machine learning model 200 (i.e., from output 302 of trained neural network 250 through weighting features 240, 242 generated by classification-based machine learning model 200 in response to synthetic tabular datasets 300).

In some implementations, training 112 classification-based machine learning model 200 is described in Equation 4:

$${min}_{θ} {\sum }_{i} ℒ ( {MLP}_{ϕ} ( {D}_{i}^{p} ) ) \qquad ( 4 )$$

where θ are the parameters of classification-based machine learning model 200's transformer, Dᵢ^{p} is the prediction portion of synthetic tabular dataset 300, MLP_{ϕ} is a feed-forward neural network with parameters given by ϕ (i.e., parameters of classification-based machine learning model 200's transformer for training data corresponding to Dᵢ^{P} for parameters θ), [symbol] is the cross entropy loss of classification-based machine learning model 200 for datasets D.

During training, the parameters θ are learned using synthetic tabular dataset 300 and are frozen. As discussed above, to apply trained classification-based machine learning model 200 to a new dataset (e.g., training dataset 208, 210, 212 and corresponding prediction dataset 214, 216, 218), classification-based machine learning model 200 processes 100 training dataset 208, 210, 212 and prediction dataset 214, 216, 218 to define 102 a plurality of weighting features (e.g., weighting features 240, 242) and to reshape 104 weighting features 240, 242 into plurality of weights (e.g., weights 246, 248). With weights 246, 248, trained neural network generation process 10 generates 108 trained neural network 250. Accordingly, trained neural network generation process 10 allows classification-based machine learning model 200 to generate trained neural networks in a single forward pass from training data and prediction data. With the trained neural network, various machine learning tasks can be performed by neural networks trained for tabular datasets directly from training data, prediction data, and a foundation model defined with the above-described classification-based machine learning model and attention layer without requiring fine-tuning of the generated neural network.

Implementations of the present disclosure develop or generate trained neural networks for tabular data processing two (e.g., using central processing units (CPUs)) or three (e.g., using graphics processing units (GPUs)) orders of magnitude faster when compared to conventional models trained using back propagation and fine-tuning. In this manner, inference time processing with the above-described classification-based machine learning model and attention layer is consistent with foundation model approaches. Accordingly, trained neural network generation process 10 provides a foundation model that continuously trains on synthetic tabular data to generate trained neural networks for processing tabular datasets directly from the foundation model two-to-three orders of magnitude more quickly than with conventional approaches.

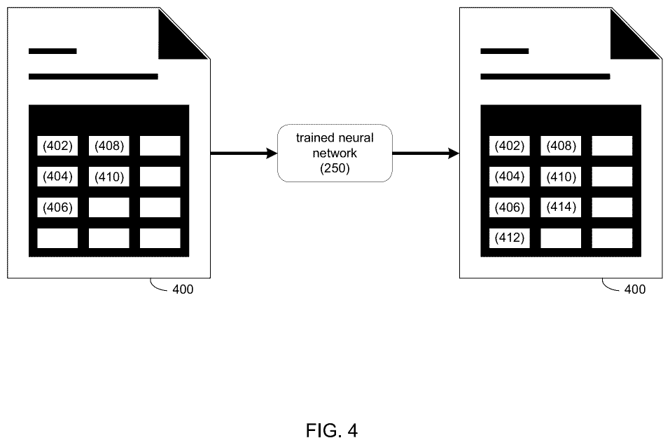

In some implementations, trained neural network generation process 10 generates 114 a prediction for a subsequent portion of tabular data by classifying the tabular data using the trained neural network based upon, at least in part, a plurality of features within the tabular data. For example and referring also to FIG. 4, suppose that trained neural network generation process 10 receives tabular data 400 to process. In this example, suppose that tabular data 400 includes a plurality of portions (e.g., portions 402, 404, 406, 408, 410) organized into columns and rows (e.g., a first column with portions 402, 404, 406 and second column with portions 408, 410 with portions 402 and 408 in a first row, portions 404 and 410 in a second row, and portion 406 in a third row). Suppose that tabular data 400 is processed (e.g., by user selection or automatically) for generating predictions for a subsequent portion. Accordingly, trained neural network 250 may classify each portion (e.g., portions 402, 404, 406, 408, 410) to generate predictions for subsequent portions (e.g., subsequent portions 412, 414) based upon, at least in part, a plurality of features (e.g., columns, rows, numbers, names, or other characteristics to identify relationships between different portions) within tabular data 400. As discussed above, trained neural network 250 is generated using classification-based machine learning model 200 in a single forward pass without requiring fine tuning of trained neural network 250. In this manner, trained neural network generation process 10 is able to generate trained neural networks that can classify tabular data, more quickly than conventional approaches (e.g., with a neural network generation speed increase of two-to-three orders of magnitude).

### System Overview:

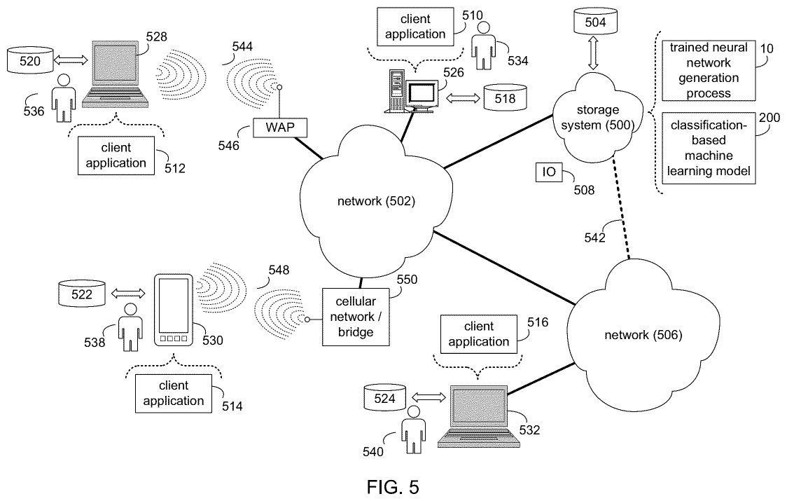

Referring to FIG. 5, a trained neural network generation process 10 is shown to reside on and is executed by storage system 500, which is connected to network 502 (e.g., the Internet or a local area network). Examples of storage system 500 include: a Network Attached Storage (NAS) system, a Storage Area Network (SAN), a personal computer with a memory system, a server computer with a memory system, and a cloud-based device with a memory system. A SAN includes one or more of a personal computer, a server computer, a series of server computers, a minicomputer, a mainframe computer, a RAID device, and a NAS system.

The various components of storage system 500 execute one or more operating systems, examples of which include: Microsoft® Windows®; Mac® OS X®; Red Hat® Linux®, Windows® Mobile, Chrome OS, Blackberry OS, Fire OS, or a custom operating system (Microsoft and Windows are registered trademarks of Microsoft Corporation in the United States, other countries or both; Mac and OS X are registered trademarks of Apple Inc. in the United States, other countries or both; Red Hat is a registered trademark of Red Hat Corporation in the United States, other countries or both; and Linux is a registered trademark of Linus Torvalds in the United States, other countries or both).

The instruction sets and subroutines of trained neural network generation process 10, which are stored on storage device 504 included within storage system 500, are executed by one or more processors (not shown) and one or more memory architectures (not shown) included within storage system 500. Storage device 504 may include: a hard disk drive; an optical drive; a RAID device; a random-access memory (RAM); a read-only memory (ROM); and all forms of flash memory storage devices. Additionally or alternatively, some portions of the instruction sets and subroutines of trained neural network generation process 10 are stored on storage devices (and/or executed by processors and memory architectures) that are external to storage system 500.

In some implementations, network 502 is connected to one or more secondary networks (e.g., network 506), examples of which include: a local area network; a wide area network; or an intranet.

Various input/output (IO) requests (e.g., IO request 508) are sent from client applications 510, 512, 514, 516 to storage system 500. Examples of IO request 508 include data write requests (e.g., a request that content be written to storage system 500) and data read requests (e.g., a request that content be read from storage system 500).

The instruction sets and subroutines of client applications 510, 512, 514, 516, which may be stored on storage devices 518, 520, 522, 524 (respectively) coupled to client electronic devices 526, 528, 530, 532 (respectively), may be executed by one or more processors (not shown) and one or more memory architectures (not shown) incorporated into client electronic devices 526, 528, 530, 532 (respectively). Storage devices 518, 520, 522, 524 may include: hard disk drives; tape drives; optical drives; RAID devices; random access memories (RAM); read-only memories (ROM), and all forms of flash memory storage devices. Examples of client electronic devices 526, 528, 530, 532 include personal computer 526, laptop computer 528, smartphone 530, laptop computer 532, a server (not shown), a data-enabled, and a dedicated network device (not shown). Client electronic devices 526, 528, 530, 532 each execute an operating system.

Users 534, 536, 538, 540 may access storage system 500 directly through network 502 or through secondary network 506. Further, storage system 500 may be connected to network 502 through secondary network 506, as illustrated with link line 542.

The various client electronic devices may be directly or indirectly coupled to network 502 (or network 506). For example, personal computer 526 is shown directly coupled to network 502 via a hardwired network connection. Further, laptop computer 532 is shown directly coupled to network 506 via a hardwired network connection. Laptop computer 528 is shown wirelessly coupled to network 502 via wireless communication channel 544 established between laptop computer 528 and wireless access point (e.g., WAP) 546, which is shown directly coupled to network 502. WAP 546 may be, for example, an IEEE 802.11a, 802.11b, 802.11g, 802.11n, Wi-Fi®, and/or Bluetooth® device that is capable of establishing a wireless communication channel 544 between laptop computer 528 and WAP 546. Smartphone 530 is shown wirelessly coupled to network 502 via wireless communication channel 548 established between smartphone 530 and cellular network/bridge 550, which is shown directly coupled to network 502.

### GENERAL

As will be appreciated by one skilled in the art, the present disclosure may be embodied as a method, a system, or a computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product on a computer-usable storage medium having computer-usable program code embodied in the medium.

Any suitable computer usable or computer readable medium may be used. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. The computer-usable or computer-readable medium may also be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present disclosure may be written in an object-oriented programming language. However, the computer program code for carrying out operations of the present disclosure may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network/a wide area network/the Internet.

The present disclosure is described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, may be implemented by computer program instructions. These computer program instructions may be provided to a processor of a general-purpose computer/special purpose computer/other programmable data processing apparatus, such that the instructions, which execute via the processor of the computer or other programmable data processing apparatus, create means for implementing the functions/acts specified in the flowchart and/or block diagram block or blocks.

These computer program instructions may also be stored in a computer-readable memory that may direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The flowcharts and block diagrams in the figures may illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, not at all, or in any combination with any other flowcharts depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

A number of implementations have been described. Having thus described the disclosure of the present application in detail and by reference to embodiments thereof, it will be apparent that modifications and variations are possible without departing from the scope of the disclosure defined in the appended claims.

What is claimed is:

1. A computer-implemented method, executed on a computing device, comprising:
processing training data and prediction data as a plurality of tokens using a classification-based machine learning model;
defining a plurality of weighting features associated with the training data and the prediction data; and
reshaping the plurality of weighting features to generate weights for a trained neural network by processing the plurality of weighting features with an attention layer.

2. The computer-implemented method of claim 1, further comprising:
generating a trained neural network using the plurality of weights.

3. The computer-implemented method of claim 2, further comprising:
generating a prediction for a subsequent portion of tabular data by classifying the tabular data using the trained neural network based upon, at least in part, a plurality of features within the tabular data.

4. The computer-implemented method of claim 2, wherein generating the trained neural network includes generating the trained neural network without subsequent fine-tuning.

5. The computer-implemented method of claim 1, wherein the training data and the prediction data are tabular data.

6. The computer-implemented method of claim 1, wherein processing the training data and the prediction data includes processing the plurality of tokens using the classification-based machine learning model in a single forward pass.

7. The computer-implemented method of claim 1, wherein the classification-based machine learning model is a foundation machine learning model trained on tabular data.

8. A computing system comprising:
a memory; and
a processor configured to train a Prior-data Fitted Network classification-based machine learning model using a plurality of synthetic tabular datasets, to process training data and prediction data as a plurality of tokens using the trained classification-based machine learning model, to reshape the plurality of weighting features to generate a plurality of weights for a trained neural network, and to generate the trained neural network.

9. The computing system of claim 8, wherein the processor is further configured to:
generate a trained neural network using the plurality of weighting features associated with the training data and the prediction data.

10. The computing system of claim 9, wherein generating the trained neural network using the plurality of weighting features includes generating the trained neural network without subsequent fine-tuning.

11. The computing system of claim 8, wherein the training data and the prediction data are tabular data.

12. The computing system of claim 8, wherein processing the training data and the prediction data includes processing the plurality of tokens using the classification-based machine learning model in a single forward pass.

13. The computing system of claim 8, wherein reshaping the plurality of weighting features includes processing the plurality of weights with an attention layer.

14. The computing system of claim 8, wherein the classification-based machine learning model is a foundation machine learning model trained on tabular data.

15. A computer program product residing on a non-transitory computer readable medium having a plurality of instructions stored thereon which, when executed by a processor, cause the processor to perform operations comprising:
processing training data and prediction data as a plurality of tokens using a Prior-data Fitted Network classification-based machine learning model in a single forward pass;
defining a plurality of weighting features associated with the training data and the prediction data;
reshaping the plurality of weighting features to generate a plurality of weights for a trained neural network; and
generating the trained neural network using the plurality of weights.

16. The computer program product of claim 15, wherein the training data and the prediction data are tabular data.

17. The computer program product of claim 15, wherein reshaping the plurality of weighting features includes processing the plurality of weighting features with an attention layer.

18. The computer program product of claim 15, wherein the classification-based machine learning model is a foundation machine learning model trained on tabular data.

19. The computer program product of claim 15, wherein generating the trained neural network using the plurality of weights includes generating the trained neural network without subsequent fine-tuning.

20. The computer program product of claim 15, wherein the operations further comprise:
training the classification-based machine learning model using a plurality of synthetic tabular datasets and back-propagation.
